(19) United States
(12) Patent Application Publication
(10) Pub. No.: US 2003/0118324 A1
(43) Pub. Date: Jun. 26, 2003

(54) Delivery of digital applications

(75) Inventor: Immo Benjes, Redhill (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/319,881

(22) Filed: Dec. 13, 2002

(30) Foreign Application Priority Data
Dec. 20, 2001 (GB) 0130407.0

(51) Int. Cl. H04N 5/91; H04N 5/781; H04N 5/85; H04N 5/90

(52) U.S. Cl. 386/83

(57) ABSTRACT

An interface module for a digital broadcast receiver comprises a transport stream generator and a storage means for holding an application, the transport stream generator being adapted to deliver an application from the storage means to the interface for reception by the receiver. In this way, the application arrives at the receiver in the manner of a broadcast application and can be dealt with in the same way. Compatibility issues are resolved since there is a standard allowing broadcast of such applications and the CI module of the invention mimics this. Third parties can deliver the application without hiring bandwidth and without having to prepare and hold inventory of multiple modules for different receivers. The module can be prepared with an application in place in situ, for example stored on a read-only memory storage means. Alternatively, the module can be supplied with a writeable and preferably non-volatile storage means to allow developers to use the module as a generic transport means. In a further development, the storage means of the module could be a removable storage media such as a CD-ROM, CD-R, CD-RW, Zip, Minidisk, tape, PCMCIA, or the like. The invention also relates to a digital broadcast receiver comprising a common interface to which is attached a module as any one defined above, and to a method of delivering an application to a digital broadcast receiver, comprising the steps of providing a module as any one defined above, storing the application on the module, and delivering the module.

The present invention relates to the delivery of digital applications to digital broadcast receivers.

Modern digital television receivers include an executing environment for interactive applications. The receiver is intended to receive applications via the broadcast signal. Third parties who wish to deliver applications to subscribers must hire bandwidth from the broadcaster. Existing receiver platforms that are suitable include the DVB Multimedia Home Platform, OpenTV, and MediaHighway. A “common interface” (CI) is also provided to allow the receiver to descramble encoded broadcast streams. CI modules are inserted into the CI and interact with the receiver.

WO 00/27114 describes an API (application programming interface) for enabling a digital television terminal to access SI (system information) from a digital transport stream without regard to the SI format via an abstracting method. It mentions that the applications used by the digital terminal can be downloaded via a network, installed at the time of manufacture, or loaded locally via a smart card. However, no mention is made as to the practicalities of doing so, nor is the CI discussed.

The present invention therefore provides an interface module for a digital broadcast receiver, comprising a transport stream generator and a storage means for holding an application, the transport stream generator being adapted to deliver an application from the storage means to the interface for reception by the receiver.

In this way, the application arrives at the receiver in the manner of a broadcast application and can be dealt with in the same way. Compatibility issues are resolved since there is a standard allowing broadcast of such applications and the CI module of the invention mimics this. Third parties can deliver the application without hiring bandwidth and without having to prepare and hold inventory of multiple modules for different receivers.

The interface module is preferably adapted for the common interface of such receivers, but the invention is applicable to interfaces that may be developed in the future.

The module can be prepared with an application in place in situ, for example stored on a read-only memory storage means. Alternatively, the module can be supplied with a writeable and preferably non-volatile storage means to allow developers to use the module as a generic transport means. In a further development of the invention, the storage means of the module could be a removable storage media such as a CD-ROM, CD-R, CD-RW, Zip, Minidisk, tape, PCMCIA, or the like.

The invention also relates to a digital broadcast receiver comprising a common interface to which is attached a module as any one defined above.

The invention further relates to a method of delivering an application to a digital broadcast receiver, comprising the steps of providing a module as any one defined above, storing the application on the module, and delivering the application.

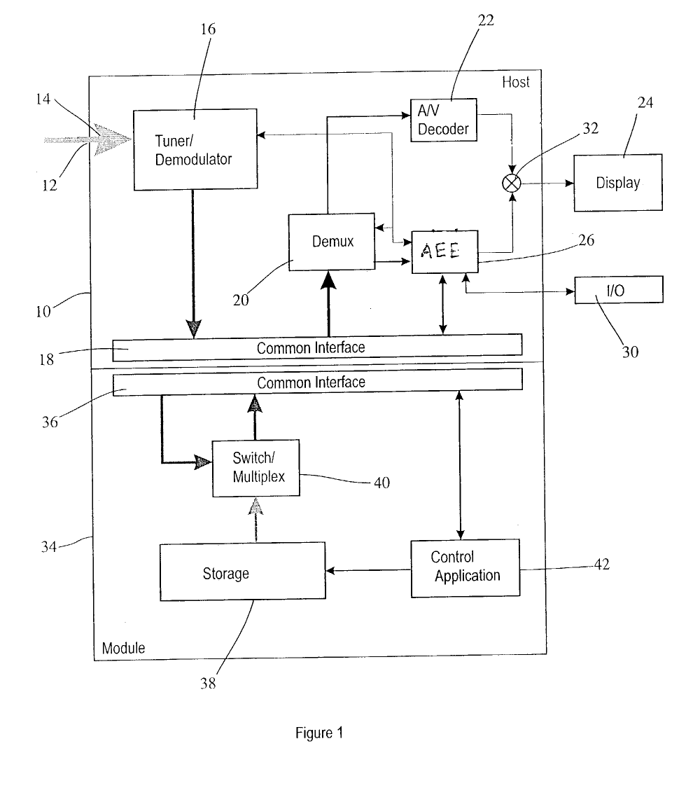

An embodiment of the invention will now be described, by way of example only, with reference to the accompanying FIG. 1, which shows in schematic form the arrangement of a digital broadcast receiver with a module attached according to the present invention.

In FIG. 1, a digital broadcast receiver 10 is fed via input 12 with a broadcast stream 14. This is delivered to a tuner/demodulator 16 from which a data stream is extracted and delivered to the common interface (CI) 18. From the host CI 18 the signal is demultiplexed at 20 and delivered to the decoder 22. The audio and video output of the decoder 22 is then viewed via a display 24.

Where an interactive application is broadcast, after delivery to the demultiplexer 20 it is fed to an application executing environment 26. This executes the application and feeds the results to the display 24 or an input/output device 30. A digital switch 32 channels the signal to the display 24 from the A/V decoder 22 and/or receives a graphics overlay produced by the application executing environment 26 as required.

FIG. 1 also shows a CI module 34 attached to the host CI 18. This includes its own CI bus 36, which mates with the CI of the host 10. Within the module 34, a storage element 38 communicates with the module CI 36 via a switcher and multiplexer 40. A control application 42 is provided to ensure proper operation.

In line with the invention, a multiplexer 40 is provided between the storage 38 and the module CI 36. This allows an application stored in the module 34 to be delivered via the module CI 36 and host CI 18 to the host demultiplexer 20 as if it had been received via the tuner/demodulator 16 from a broadcast signal 14. According to the invention, standard transmission formats can be implemented in the module 34 corresponding to the transmission formats of the broadcast signal 14.

It will of course be appreciated that many variations may be made to the above-described illustrative embodiment without departing from the present invention. In particular, the Firewire standard may be used as the protocol for the hardware and delivery method of the application via the common interface.

1. An interface module for a digital broadcast receiver, comprising a transport stream generator and a storage means for holding an application, the transport stream generator being adapted to deliver an application from the storage means to the interface for reception by the receiver.

2. An interface module according to claim 1 in which the interface module is adapted for the common interface of a digital broadcast receiver.

3. An interface module according to claim 1 in which the module includes an application in place in the storage means.

4. An interface module according to claim 1 in which the storage means is read-only.

5. An interface module according to claim 1 in which the storage means is writeable.

6. An interface module according to claim 5 in which the writeable storage means is non-volatile.

7. An interface module according to claim 1 in which the storage means of the module is a removable storage media.

8. An interface module according to claim 7 in which the removable storage media is one of a CD-ROM, CD-R, CD-RW, Zip, Minidisk, tape and PCMCIA media.

9. A digital broadcast receiver comprising a common interface to which is attached a module according to claim 1.

10. A method of delivering an application to a digital broadcast receiver, comprising the steps of providing a module according to any one of the preceding claims, storing the application on the module, and delivering the application.
